(19) United States
(12) Patent Application Publication
(10) Pub. No.: US 2008/0026150 A1
(43) Pub. Date: Jan. 31, 2008

(54) Silica-Free Surface Abrasion Compositions and Their Uses

(75) Inventors: Robert Louis Mesa, Santa Clara, CA (US); Edward W. Woodhall, Los Altos, CA (US)

Correspondence Address: BEYER WEAVER LLP, P.O. BOX 70250, OAKLAND, CA, 94612-0250, US

(73) Assignee: Cal-West Specialty Coatings, Inc.

(21) Appl. No.: 10/572,165

(22) PCT Filed: Dec. 1, 2004
(86) PCT No.: PCT/US04/40566

§ 371 Date: Apr. 17, 2007

Related U.S. Application Data
(60) Provisional application No. 60/527,090, filed on Dec. 3, 2003.
(60) Provisional application No. 60/609,701, filed on Sep. 13, 2004.

(51) Int. Cl. C09K 3/00

(52) U.S. Cl. 427/299; 51/293; 51/298; 51/300; 51/304; 51/306; 51/307; 51/308; 51/309

(57) ABSTRACT

This invention provides for provides for abrasive compositions and methods of use of these compositions for the preparation of surfaces for the application of various coatings such as paints, lacquers and varnishes. The abrasive compositions of the invention provide rapid cleaning and dulling of the underlying surface rendering it suitable for the application of paints or other finishes.

### CROSS-REFERENCE TO RELATED APPLICATIONS

This application claims priority to and benefit of U.S. SN 60/609,701, filed on Sep. 13, 2004, and U.S. SN. 60/527,090, filed on Dec. 3, 2003, both of which are incorporated herein by reference in their entirety for all purposes.

### STATEMENT AS TO RIGHTS TO INVENTIONS MADE UNDER FEDERALLY SPONSORED RESEARCH AND DEVELOPMENT

[Not Applicable ]

### FIELD OF THE INVENTION

The present invention relates to abrasive compositions and their use in the preparation of surfaces for the application of paint.

### BACKGROUND OF THE INVENTION

The proper application of various finishing materials, in particular high-gloss paint finishes, typically requires cleaning and abrasion of the underlying surface in order to provide a surface that forms a strong adhesive bond with the newly applied finishing material. Cleaning and abrasion of the underlying surface is particularly important to the successful finishing of surfaces that are dirty, oily, greasy, or otherwise soiled and/or have a preexisting finish (e.g., a primer or undercoat, or a high gloss finish).

Surface finishing processes are particularly common in the automotive industry. Motor vehicles (e.g., cars, trucks, motorcycles, etc.) are frequently subject to elaborate painting processes during the manufacture or subsequent refinishing of the vehicle. These processes often require application of numerous coats of paint (or other finish) and the application of each coat typically requires preparation (e.g., cleaning and abrading) of the underlying surface.

Vehicle surfaces typically bear high gloss acrylic or urethane finishes, often with a wax or polybond topcoat. In addition, vehicle surfaces are often soiled with dirt and/or grease, either from the manufacturing operation or subsequent use, and thus provide surfaces that must be cleaned prior to application of a subsequent coating. Even during vehicle assembly, components are often supplied with a primers or undercoats that must be cleaned and abraded to enhance the adhesion of the subsequently applied coating.

Surface abrasion is often accomplished with the use of scuff-pads, abrasive pads, sanding, or sand blasting. These approaches are typically expensive, time-consuming, and laborious and usually require subsequent cleaning and degreasing.

While the use of abrasive compositions for surface cleaning and abrasion is generally known, most abrasive compositions do not provide a surface well suited to the subsequent application of finishes. Typical abrasive compositions include polishing or rubbing compounds, abrasive cleansers, and abrasive compositions for the removal of oxidation layers (e.g., rust removal compositions). Of these, rust removal and abrasive cleansers are most appropriate for the preparation of surfaces for subsequent coating operations as rubbing compounds tend to increase polish and shine rather than dully underlying surfaces.

Abrasive cleansers (scouring powders) and rust removal compounds, however, have proven unsatisfactory as surface preparatives. Scouring powders often fail to provide adequate or consistent (uniform) dulling of the underlying surface. In addition, scouring powders typically include a soap that leaves a residual film which has proven difficult to remove and which interferes with the adhesion of subsequently applied finishes. A similar problem has been observed with various abrasive pastes.

Rust removal compositions typically include an acid degreaser use of which entails some health risk and requires protective equipment. The acid component of rust removal compositions may also attack chrome trim which may be present on the surface. Finally, paste-like silicate abrasives which are more easily removed front the underlying surfaces, tend to dry out to powders which become airborne and provide a significant airborne health hazard.

### SUMMARY OF THE INVENTION

The present invention provides for abrasive compositions and methods of use of these compositions for the preparation of surfaces for the application of various coatings or finishes such as paints, lacquers and varnishes. The abrasive compositions of the present invention provide rapid cleaning and dulling of the underlying surface with little effort, increase the useful life of abrasive devices such as scuff pads, are easily removed from the abraded surface with only a water rinse, and provide no significant environmental impact.

In certain embodiments, this invention provides a composition for preparing a plastic surface for application of paint or other overcoating. The composition typically comprises about 1.0% to about 80%, by weight, a particulate abrasive; and about 0.1% to about 10%, by weight a suspension agent, where the composition lacks an aliphatic hydrocarbon cleaning agent.

In certain embodiments this invention provides compositions for preparing a plastic surface for application of paint or other overcoating material. The compositions typically include about 1.0% to about 80%, by weight, a particulate abrasive; and about 0.1% to about 10%, by weight a suspension agent, where the composition lacks an aliphatic hydrocarbon cleaning agent. In certain embodiments the particulate abrasive is selected from the group consisting of a pumice, calcium carbonate, ninex, boron nitride, metal carbides, diamond dust, aluminum oxide, and iron oxide. In certain embodiments the particulate abrasive comprises a feldspar. Certain preferred particulate abrasives have a mohs hardness of 9. In certain embodiments the particulate abrasive comprises fused aluminum oxide (e.g., Minspar 3™). Typically the particulate abrasive has a particle size and hardness sufficient to dull a paint finish on said plastic surface (e.g., a surface of a plastic automobile part such as an automobile bumper or other part). In various embodiments the suspension agent is selected from the group consisting of a cellulose, a starch, an acrylic polymer, a polymer emulsion, and a clay. In various embodiments the suspension agent comprises a copolymers of acrylic acid and a polyalkenyl polyether (e.g., Carbopol™ copolymer). In certain embodiments the suspension agent is selected from the group consisting of CARBOPOL EZ-1™, and CARBOPOL EZ-3™. In various embodiments the composition further comprises a surfactant (e.g., a high II. surfactant and a low HLB surfactant). In certain embodiments the surfactant further comprises an ionic surfactant and/or a nonionic surfactant. In certain embodiments the surfactant comprises an ethoxylated linear alcohol (e.g., a poly (3) oxyethylene C₁₂₋₁₅ alcohol, a poly (7) oxyethylene C₁₂₋₁₅ alcohol, etc.). The composition can optionally, further comprise a humectant. When present, the humectant typically ranges from about 0.1 to about 20%, by weight, of the composition. In certain embodiments the humectant comprises glycerine and/or polyethylnene glycol. In certain embodiments the composition further comprises a pH adjuster. In various embodiments the composition further comprises a surfactant (e.g., Tomadol 25-7, Tomadol 25-3, and/or Aerosol OT-75), a humectant (e.g., glycerine and/or polyethylene glycol 400), and a pH adjuster (e.g., triethanolamine).

In another embodiment, this invention provides a method of coating a plastic surface with paint or other overcoating. The method typically involves abrading the plastic surface with a composition as described above, removing the composition from the surface; and applying the paint or other overcoating to the plastic surface. In certain embodiments the plastic surface is not pre-baked and/or degreased prior to application of the paint or other overcoating. In certain embodiments the plastic surface is a surface of a component (e.g., a bumper or other component) of a motor vehicle.

This invention also provides a method of preparing a plastic surface for coating with paint or other overcoating material. The method typically involves providing an article of manufacture comprising a plastic surface; and abrading the plastic surface with a composition s described above. In certain embodiments the plastic surface is not pre-baked and/or not degreased prior to application of the overcoating. In certain embodiments the plastic surface is a surface of a component (e.g., a bumper) for a motor vehicle.

In another embodiment, this invention provides a composition for preparing a surface for application of paint or other overcoating. The composition typically includes about 1.0% to about 80%, by weight, a particulate abrasive, where the particulate abrasive lacks silica; and about 0.1% to about 10%, by weight a suspension agent. In certain embodiments the particulate abrasive is selected from the group consisting of a pumice, calcium carbonate, ninex, boron nitride, metal carbides, diamond dust, aluminum oxide, and iron oxide. In certain embodiments the particulate abrasive comprises alundum. In certain embodiments the particulate abrasive comprises nepheline syenite. In certain embodiments the particulate abrasive has a mohs hardness of 9. In certain embodiments the particulate abrasive comprises fused aluminum oxide. In various embodiments the composition lacks an aliphatic hydrocarbon cleaning agent. In various embodiments the particulate abrasive typically has a particle size and hardness sufficient to dull a paint finish on said surface (e.g., the surface of a motor vehicle., a painted surface of a motor vehicle, etc.). In various embodiments the suspension agent is selected from the group consisting of a cellulose, a starch, an acrylic polymer, a polymer emulsion, and a clay. In various embodiments the suspension agent comprises a copolymer of acrylic acid and a polyalkenyl polyether. In various embodiments the suspension agent is a Carbopol™ copolymer (e.g., CARBOPOL EZ-1™, and/or CARBOPOL EZ-3™). In various embodiments the composition further comprises a surfactant (e.g., a high HLB surfactant and a low HLB surfactant). In various embodiments the surfactant further comprises an ionic surfactant and/or a nonionic surfactant. In certain embodiments the surfactant comprises an ethoxylated linear alcohol (e.g., a poly (3) oxyethylene C₁₂₋₁₅ alcohol, a poly (7) oxyethylene C₁₂₋₁₅ alcohol, and/or the like). In various embodiments the composition further comprises a humectant (e.g., glycerine, polylethylene glycol, etc.). In various embodiments the humectant ranges from about 0.1 to about 20%, by weight, of said composition. In various embodiments the composition further comprises a pH adjuster. In various embodiments the composition further comprises: a surfactant (e.g., Tomadol 25-7, Tomadol 25-3, and/or Aerosol OT-75), a humectant (e.g., glycerine and/or polyethylene glycol 400), and a pH adjuster (e.g., triethanolamine).

In certain embodiments this invention provides a method of preparing a surface for application of a finish. The method typically involves abrading the surface with an abrasive composition as described above and removing said abrasive composition from said surface. In various embodiments the surface is a painted or otherwise coated metal surface or a bare metal surface. In various embodiments the surface is the surface of a motor vehicle (e.g., an automobile).

This invention also provides a method of coating a surface (e.g., a plastic surface) with paint or other overcoating. The method typically involves abrading said plastic surface with an abrasive composition as described herein and removing the composition from the surface; and applying paint or other overcoating to the surface. In various embodiments the surface is a surface of an automobile or automobile part. In certain embodiments the surface is a painted surface of an automobile. In various embodiments the removing comprises washing the surface with water.

In still another embodiment, this invention provides a method of coating a painted surface, where said painted surfaces comprises nanoceramic particles. The method typically involves abrading the paint surface with a foam or gel comprising: about 1.0% to about 80% by weight of a particulate abrasive wherein said particulate abrasive is an aluminum oxide having a mohs hardness of about 9; about 0.1% to about 10% by weight of a suspension agent; and a surfactant; and removing said foam or gel from said surface. In certain embodiments the particulate abrasive comprises about a 360 grit particle size. In certain embodiments the foam or gel further comprises a cleaning agent (e.g., an aliphatic hydrocarbon). In various embodiments the suspension agent is selected from the group consisting of a cellulose, a starch, an acrylic polymer, a polymer emulsion, or a clay. In various embodiments the particulate abrasive comprises about 10% to about 50% by weight of the composition. In various embodiments the surfactant comprises a high HLB surfactant and a low HLB surfactant. In various embodiments the surfactant further comprises an ionic surfactant. In certain embodiments the cleaning agent comprises about 0.1% to about 5% by weight of the composition. In various embodiments the cleaning agent comprises a water soluble alcohol. In various embodiments the composition further comprises a neutralizing agent. In certain embodiments the cleaning agent comprises one or more agents selected from the group consisting of ethyl alcohol, propyl alcohol, isopropyl alcohol, methyl alcohol, ethylene diol, propylene diol, ethanolamine, D-limonine, dodecane, and isopar G, ethoxylate, and Carvone. In certain embodiments the cleaning agent is ethyl alcohol and D-Limonine. In various embodiments the composition further comprises a foam height stabilizer (e.g., ninol). In various embodiments the surfactant comprises a nonionic high HLB surfactant, a nonionic low HLB surfactant, and an ionic surfactant. In certain embodiments the particulate abrasive comprises about 50 to about 85% of said composition by weight. In certain embodiments the particulate abrasive comprises about 75% of said composition by weight, the nonionic high SIT surfactant and nonionic low HLB surfactant each comprise about 0.5%, by weight, of said composition; the ionic surfactant comprises about 0.67%, by weight, of said composition; the cleaning agent is D-Limonine and comprises about 2%, by weight, of said composition. In certain embodiments the composition further comprises a humectant.

### DETAILED DESCRIPTION

The present invention provides for abrasive compositions and methods of use of these compositions for the preparation of surfaces for the application of various coatings such as paints, lacquers and varnishes. The abrasive compositions of the present invention provide rapid cleaning and dulling of the underlying surface with little effort, increase the useful life of abrasive devices such as scuff pads, are easily removed from the abraded surface with only a water rinse, and provide no significant environmental impact.

In certain embodiments, this invention contemplates abrasive coatings particularly well suited for preparing plastic surfaces for painting or coatings with other overcoatings (e.g., clear coat, lacquer, varnish, etc.). In certain preferred embodiments, such abrasive coatings comprise aqueous mixtures/suspensions comprising a about 1.0% to about 80%, by weight, a particulate abrasive; and about 0.1% to about 10%, by weight a suspension agent. The compositions can additionally and optionally include a humectant, and/or a surfactant, and/or a biocide, and/or a colorant, and/or a scent, and the like, e.g., as described herein.

It was a surprising discovery that such abrasive compositions, particularly those lacking an aliphatic hydrocarbon cleaning agent (e.g., d-limonene) are highly effective for preparing plastic surfaces for painting or other overcoating operations. Thus, in certain embodiments, the abrasive compositions lack an aliphatic hydrocarbon cleaning agent.

It was a surprising discovery that use of such abrasive compositions reduces or eliminates the need for expensive pre-baking of new plastic parts before painting. (Most paint manufactures at one time or another recommended or still recommend pre-baking). In addition the use of the compositions typically eliminates the need for initial and sometimes repetitive de-greasing of new and used plastic parts. This is particularly advantageous sin reducing total VOC output in preparing a part. It is also noted that use of the abrasive compositions on plastics greatly reduces the likelihood of paint adhesion failures. In certain instances, a 20% failure rate on painted plastic bumpers has been observed when using the paint manufacturer's preparation instructions. After using the compositions of this invention, the failure rate dropped to less that 1% it was no longer necessary to pre-bake the plastic parts.

In certain embodiments, this invention provides novel abrasive compositions for use on essentially any surface, but most preferably a painted surface of an automobile. Such compositions typically comprise an aqueous mixture/suspension of about 1.0% to about 80%, by weight, a particulate abrasive, where the particulate abrasive lacks silica; and about 0.1% to about 10%, by weight a suspension agent. The compositions can additionally and optionally include a humectant, and/or a surfactant, and/or a biocide, and/or a colorant, and/or a scent, and the like, e.g., as described herein. In certain particularly preferred embodiments, the particulate abrasive comprises alundum and/or nepheline syenite.

In addition to the aforementioned advantages, the abrasive compositions of the present invention provide unusually consistent abrasion. Unlike sanding and other techniques that often result in an irregularly dulled surface, the compositions of this invention provide and extremely uniform dulling with a minimum of individual scratches visible to the naked eye. This results in particularly even distribution of subsequent finishes. This is especially important to the application of metallic and multiple stage paints which tend to render even minor underlying discontinuities highly visible.

With the use of less aggressive solvent systems in paints and other finishes, due to concern over environmental impact, surface preparation has become increasingly important to ensure adhesion of the finish. The extremely consistent and effective dulling of the underlying surface coupled with easy and complete removal of the abrasive composition with only a water wash has been shown to result in unusually effective adhesion of subsequently applied finishes.

Thus, in one embodiment, this invention provides for a method of preparing a surface (e.g., a plastic bumper, a painted automobile surface, etc.) for application of a coating. The method involves abrading the surface with one of the abrasive compositions of this invention and then removing the abrasive composition from the surface.

One of skill in the art will appreciate that the abrasive compositions of this invention may be used on virtually any surface. However, in a preferred embodiment, the abrasive compositions will be used on a metal, rubber, or plastic surface. The surface can be bare metal, oxidized metal, metal already coated with a primer or undercoat, or metal coated with a final or finish coat. Similarly, suitable plastic or rubber surfaces may be bare or coated with a primer, undercoat, or finish coat. The abrasive compositions of this invention may be used on any coatings known to those of skill in the art, including, for example, paints (e.g., acrylic or urethane), varnishes, lacquers, and the like.

As indicated above, use of the abrasive compositions on plastic surfaces typically obviates the need for pre-baking and/or degreasing of the plastic.

The abrasive compositions may be used on any metal (or other) surface that is to be subsequently coated with a finish. This may include, but are not limited to metallic (e.g., aluminum) siding, metallic fencing, appliance sidings, metallic components of virtually any article of manufacture. The abrasive compositions of the present invention, however, are particularly well suited to the preparation of vehicles, in particular to the metal or plastic surfaces of motor vehicles such as cars, trucks, motorcycles, multi-purpose vehicles (MPVs), and the like. In a particularly preferred embodiment, the abrasive compositions are used to prepare metal or plastic surfaces for the application of acrylic automotive paints.

Typically, the abrasive composition is applied either directly to the surface to be prepared or to an applicator, a device that will be used to apply the abrasive composition to the surface. Application directly to the surface or to the applicator may be by any means well known to those of skill in the art including pouring directly on the surface, dipping the surface, spraying, application by roller, pumping, and the like. The applicator can additionally contain a reservoir that is filled with the abrasive composition and that delivers the composition to the surface of the applicator through one or more channels. The composition may be delivered through the channels by passive flow or under pressure, for example, by pumping or pressurized gas.

After application to either the surface or the applicator, the abrasive composition is rubbed against the underlying surface thereby cleaning and abrading the surface. In a preferred embodiment, the applicator is used to rub the abrasive against the surface. Suitable applicators are well known to those of skill in the art and include, but are not limited to cloth or cloth pads, scouring pads, sponges, scuff pads, brushes, sandpaper, abrasive matrix materials, and the like.

The rubbing action can be provided by manual manipulation of the application device or through use of a motorized application device such as a rotary sander or buffer, random orbital sander, belt sander, roller applicators, and the like which are well known to those of skill in the art.

Visual inspection is sufficient to determine when the underlying surface is sufficiently abraded (dulled) to permit successful application of the subsequent finish. However, because of the extremely uniform and consistent abrasion provided by the abrasive compositions of this invention, the methods of this invention are suitable for automated determination of the appropriate endpoint for the abrasive process. This may be accomplished simply by running an automated abrasion device for a fixed time period, of by the use of an optical system that detects dullness of the underlying surface and stops the abrasion process at the appropriate endpoint.

When the underlying surface is sufficiently cleaned and abraded, the abrasive composition is removed. This may be accomplished by any convenient mechanical and/or chemical means. Suitable mechanical means include scrapers, squeegees, wiping (as with a cloth, brush, or sponge) and the like. The mechanical means may be used alone, or in conjunction with an appropriate solvent. In one particularly preferred embodiment, removal is by washing with water.

The surface can then be dried by any means generally known to those of skill in the art including, but not limited to, air drying or force drying, for example, by the application of heat (e.g., radiant heating, oven baking, or hot air blowers), the reduction of air humidity, an increase in air movement or any combination of these means. One of skill will appreciate that certain finishes (e.g., water soluble latex paints) may not require drying of the surface prior to application of the finish.

The cleaned and dulled surface is then ready for application of a suitable finishing material such as a paint, or other overcoating including, but not limited to lacquer, or varnish, according to standard methods well known to those of skill in the art.

In certain embodiments, the abrasive compositions of the present invention are aqueous suspensions of a particulate abrasive. Thus, the compositions typically include an abrasive component and a suspension agent (to keep the abrasive component in suspension) with water generally providing the remainder of the composition. In various preferred embodiments, the compositions can additionally include surfactants to provide lubrication and to improve wetting of the underlying surface, and/or hydration agents (humectants) to prevent dehydration of the abrasive composition during use.. The composition can also include various other additives such as pigments or dyes for coloration, fragrances, UV blocking components, neutralizing compounds to regulate pH, foam height stabilizers, to maintain gel consistency, and the like. While certain cleaning agents can be included to provide additional degreasing and cleaning activity, it was a surprising discovery that such aliphatic hydrocarbon cleaning agents (e.g., d-limonene) are not necessary and indeed, are often preferably omitted.

The particulate abrasive used in the abrasive composition may include any material having suitable strength, integrity, hardness and the like to provide the required abrading treatment to the surface to be treated. It will be appreciated that the requirements for the abrasive material will vary depending upon the surface to be treated and the desired effect on the surface. Generally, the particulate abrasive is selected so as to give effective abrasive action that uniformly dulls an underlying finish without undue scratching. Relatively soft abrasive materials can be suitable in certain applications and indeed may be desirable where the surface is of a consistency that cannot withstand severe treatment. However, on most surfaces, relatively hard particulate abrasives are preferred. Suitable abrasives include pumice, silica, calcium carbonate, ninex, boron nitride, various metal carbides, diamond dust, various metal oxides such as aluminum oxide, iron oxide, and the like.

While various silicates, especially various alkalai metal silicates (e.g., feldspar) can provide an effective abrasive, it was also a surprising discovery that certain silica-free embodiments are equally or even more efficacious. In certain preferred silica-free embodiments, the particulate abrasive comprises nepheline syenite and/or alundum.

One of skill will appreciate that preferred particle size varies with the hardness of the particle and the finish on the surface that is to be abraded. Particle size can be adjusted according to methods well known to those of skill in the art. For example, an abrasive gel composition of the present invention is made up with a particular particle size and used on a representative test panel. If excessive scratching is observed, then the particle size is reduced. Conversely, if the composition shows inadequate abrasive action, the particle size is increased.

In certain embodiments, a suitable abrasive particle has a mean particle size of about 12 μm and a Mohs hardness ranging from about 6.0 to about 6.5. A preferred particle size distribution is one in which substantially the whole of the particulate material, when dry, passes through a 100 Mesh Sieve and at least 50%, more preferably 75% and most preferably about 90% passes through a 325 mesh sieve. Particularly preferred abrasives include feldspars comparable to MISPAR 170 and MINSPAR 200, Minspar 3, and crystalline silicas comparable to TAMSIL-75 and TAMSIL-150 (Unimin Specialty Minerals Inc., Tamms, Ill.) which are illustrated in Table 1.

TABLE 1
Particle size distribution of MINISPAR, TAMSIL-75
and -TAMSIL-150.

| | MINSPAR | | |
|---|---|---|---|
| | 200 | TAMSIL-75 | TAMSIL-150 |
| 50 Mesh Sieve, % retained | — | 0.00 | 0.00 |
| 70 Mesh Sieve, % retained | — | 0.00 | 0.01 |
| 100 Mesh Sieve, % retained | trace | 0.02 | 1.11 |
| 140 Mesh Sieve, % retained | 0.02 | 0.15 | 3.71 |
| 170 Mesh Sieve, % retained | 0.08 | — | — |
| 200 Mesh Sieve, % retained | 0.30 | 2.00 | 8.81 |
| 270 Mesh Sieve, % retained | — | 7.69 | 16.01 |
| 325 Mesh Sieve, % retained | 3.60 | 11.10 | 20.11 |

In certain embodiments, the particulate abrasive lacks silica Suitable formulations include, but are not limited to, formulations comprising alundum (e.g., acid treated alundum (Saint Gobain 38 alundum acid treated) and/or nepheline syenite (Unimin Co.).

An abrasive content of about 10% to about 85% has been found suitable, with about 10% to about 70% being preferred, about 20% to about 65% being more preferred and about 30% to about 60% being most preferred. In a number of embodiments, about 55% to about 60% particulate abrasive has proven particularly effective.

The abrasive compositions of the present invention preferably include a suspension agent to maintain the particulate abrasive in an aqueous suspension. Without being bound to a particular theory, it is believed that the inclusion of a suspension agent improves the homogeneity of the composition and prevents clumping of the particulate abrasive. In use, a composition comprising a homogeneously distributed particulate abrasive results greater uniformity of abrasive action over the underlying surface. The suspension agent thereby facilitates the even dulling of the underlying surface without distinct or visible scratches. The reduction of distinct or visible scratches is desirable because such discontinuities tend to accumulate the subsequently applied coating resulting in an uneven finish.

In addition, it is believed the suspension agent acts to suspend particles abraded off of the underlying surface. By clearing (suspending) the abraded particles away from the underlying surface, new surface is constantly exposed to the abrasive particles thereby causing rapid abrasion of the underlying surface. In addition, the material abraded off, does not clump and is less likely to act as an abrasive particle itself which might otherwise unduly scratch the underlying surface. Finally, suspension of the abraded particles prevents clogging or “filling” of the application device. This effectively prolongs the useful life of the applicator (e.g., scouring pad, sandpaper, or brush).

Essentially any water soluble thickener can act as a suitable suspension agent. However, preferred suspension agents are easily washed off of the underlying surface without leaving a residual film that may interfere with subsequently applied coatings. Particularly preferred suspension agents form a gel or foam (as opposed to a paste or film) that is easily removed with water. Thickening agents are well known to those of skill in the art and include natural product thickeners such as cellulose, cellulose derivatives (e.g., hydroxycellulose, methylcellulose, hydroxyethylcellulose, hydroxymethylcellulose, etc.), starch or modified starches, dextrins, and the like.

Various natural and synthetic clay type suspension agents can also be used. Suitable natural clays include attapulgite and bentonite. An example of a synthetic clay is an inorganic complex silicate clay. Several grades of synthetic clay are available as Laponite™ (e.g., from Laporte Industries Limited). Other useful suspending agents are the finely divided hydrophobicly treated clays such as a reaction product of a clay, such as a bentonite, hectorite or Laponite, with, for example, dimethyldisteryl ammonium chloride. These suspending agents are the hydrophobically treated montmorillonite or hectorite clays available under the tradename BENTONE® which are prepared by reacting a clay such as bentonite or hectorite in a cation exchange system with a variety of amines. Different amines are reacted to obtain different BENTONE® suspending agents which may also differ in proportions of SiO₂, MgO and AlO₃. Examples of useful BENTONE® suspending agents are Bentone-27 which is a stearaluminum hectorite, Bentone-34 which is a quaternium 18 bentonite, Bentone-38 which is a quaternium 18 hectorite and Bentone-14 which is a clay extended quaternium 18 hectorite, all of which have a particle size of below about 5 microns and are commercially available.

Particularly preferred thickeners include various polymer or polymer emulsion thickeners such as silicone based thickeners, acrylic emulsion thickeners (e.g., CARBOPOL® EP1, CARBOPOL® 1324, etc.) and acrylic copolymers (e.g., CARBOPOL® EZ-1, CARBOPOL® EZ-3) and the like.

The amount of suspension agent in the abrasive composition is variable, however, in a preferred embodiment, the amount of suspension agent is adjusted to provide a gelatinous or foam-like consistency. In a preferred embodiment, the thickener can be present at about 0.1% to about 10%, preferably at about 0.1% to about 7%. by weight, more preferably at about 0.2% to about 5%, by weight of the total composition. Typically, clay and polymer thickeners are preferably present at a lower concentration (e.g., about 1.5% to about 3%, by weight) than polymer emulsions (e.g., about 6% to about 7%, by weight).

As indicated above, the abrasive compositions of the present invention typically do not include a cleaning agent, however, in certain embodiments, such a cleaning agent can be present. When present, the cleaning agent acts to remove grease, oils, and other soiling materials. Preferred cleaning agents are those that leave no residual film or contaminant that may interfere with the subsequent bonding of a coating material (e.g., acrylic paint). While water insoluble cleaning agents are suitable, to facilitate compounding into an aqueous based abrasive composition and to facilitate removal of the composition once the underlying surface is suitably cleaned and abraded, water-soluble cleaning agents are preferred.

Particularly preferred water soluble cleaning agents include one or more water soluble alcohols and/or one or more aliphatic hydrocarbons. Water soluble alcohols are well known to those of skill in the art and include, but are not limited to ethyl alcohol, methyl alcohol, propyl alcohol, isopropyl alcohol, ethylene diol, propylene diol, ethanolamine, and the like. Absolute alcohols are suitable although 95% alcohols are preferred.

The alcohols generally increase wetting of the underlying surface by the abrasive composition. In addition the alcohols facilitate the dispersion of low HLB surfactants, if they are present.

When an alcohol is present in the abrasive composition, it is preferably present at about 0.1% to about 5%, more preferably about 0.5 to about 3.0% and most preferably about 1.0% to about 2.0%, by weight, of the total abrasive composition.

When present, the cleaning agent can comprise one or more aliphatic hydrocarbon cleaning solvents, alone or in combination with the alcohol. Preferred hydrocarbon cleaning solvents relatively nontoxic. Suitable aliphatic hydrocarbon cleaning agents are well known to those of skill in the art and include, but are not limited to, cyclic monoterpenes such as Carvone or Limonine, or other hydrocarbon cleaning agents such as dodecane, isopar-G, and the like.

When an aliphatic hydrocarbon cleaning solvent is present, it is preferably present at about 0.1% to about 5%, more preferably about 1% to about 3% and most preferably at about 1.0% to about 2.0%, by weight, of the total composition.

When present, in certain preferred embodiments, the cleaning agent includes both a water soluble alcohol and a hydrocarbon cleaning solvent. In a particularly preferred embodiment, the ratio of alcohol to hydrocarbon solvent is about 1:2, by weight. In one preferred embodiment, the abrasive composition comprises about 1%, by weight, alcohol and about 2%, by weight hydrocarbon solvent, with a combination of ethyl alcohol and limonine being particularly suitable.

In certain embodiments, the abrasive compositions of the present invention can include one or more surfactants. The surfactants improve wetting of the underlying surface, facilitate solubilization of oils, greases and other soiling materials, and provide lubrication for the abrading process, as well.

Suitable surfactants include ionic surfactants (cationic or anionic), nonionic surfactants, and amphoteric surfactants. Examples of nonionic surfactants include monoethers of polyethylene glycols and long chain alkanols in which the alkanol has 10 to 16 carbon atoms and the polyethylene glycol has 5 to 15 oxyethylene units. Such monoethers of polyethylene glycol are generally made by reacting the alkanol with ethylene oxide. Such nonionic surfactants are well known to those of skill in the art and are commercially available. For example, commercially available TOMADOL® 25-7, a nonionic surfactant, is an adduct of 7 mols of ethylene oxide and 1 mol of a mixture of alkanols of 12 to 15 carbon atoms. Other related nonionic surfactants include TOMADOL® 25-3, NEODOL® 4511, NEODOL®2503, ALFONIC® 1618-65, PLURAFAC® B26, and the like.

Ionic surfactants include anionic and cationic surfactants. Suitable anionic surfactants are well known to those of skill in the art and include, but are not limited to various carboxylates, N-acylsarcosinates, acylated protein hydrolysates including various sulfonates, ethoxylated and/or sulfonated alkylphenols, and the like. Cationic surfactants are also well known to those of skill in the art and include, but are not limited to aliphatic mono-, di- and polyamines derived from fatty and rosin acids, quaternary ammonium salts, and the like.

Suitable amphoteric surfactants include, but are not limited to, the alkylbetaines, alkyldimethylamines, amphoteric imidazolinium derivatives, and the like.

In certain embodiments, the surfactant includes two nonionic surfactants, one a low hydrophile-lipophile balance (HLB) surfactant and the other a high (HLB) surfactant. (The hydrophile-lipophile balance is an expression of the relative simultaneous attraction of surfactant for water and for oil [or for the two phases of the emulsion system being considered]). Without being bound to a particular theory, it is believed that the low HLB surfactant partitions into the hydrocarbon (hydrophobic) phase of the abrasive composition (which will also include oily contaminants on the underlying surface) effectively incorporating some water into the hydrophobic phase. The high HLB surfactant then acts as an emulsifier effectively solubilizing the HLB surfactant. In a particularly preferred embodiment, nonionic low HLB and high HLB surfactants are combined with a high foaming ionic surfactant which provides foam height and helps lift abraded particles, dirt and oil up away from the underlying surface.

As used herein, a low HLB surfactant is one which has an HLB number ranging from about 3 to about 8, while a high HLB surfactant is one which has an HLB number ranging from about 9 to about 2.

In certain embodiments, the surfactant comprises TOMADOL® 25-3 (Tomah, Inc.) as the low HLB surfactant (HLB number about 7.8) and TOMADOL® 25-7 (Tomah, Inc.) as the high HLB surfactant (HLB number about 12.3) and RHODAPLEX® CO 436, sodium dodecyl sulfate, dioctylsodiumsulfosuccinate (e.g., ACROSOL® OT-75), STEOL® CA460, or STEOL® CS460 as the high foaming surfactant. Other suitable high HLB, low HLB and high foaming surfactants will be known to those of skill in the art.

The total surfactant comprises about 0.01% to about to about 6.0%, more preferably about 0.01 to about 3.0% and most preferably about 0.1% to about 2.0% of the total composition. The high and low HLB surfactants are preferably present in equal concentration with the concentration of each ranging from about 0.01% to about 2%, more preferably about 0.01% to about 1% and most preferably about 0.01% to about 0.5% of the total abrasive composition. The high foaming surfactant is preferably present in a concentration equivalent to the combined high and low HLB surfactants, with a concentration preferably ranging from about 0.01% to about 2%, more preferably from about 0.01% to about 1.5%, and most preferably from about 0.01% to about 1% of the total abrasive composition.

To improve foam height and thereby particle suspension properties, the abrasive composition can include a foam height stabilizer. Preferred foam height stabilizers, especially the fatty acid amides, also increase detergency and adhere to metals surfaces thereby improving lubricicity. Again, preferred foam height stabilizers are easily removed with a water wash. Suitable foam height stabilizers include, but are not limited to, various substituted fatty acid amides such as Ninol, Maypon, Sarkosyl, Igepon, Hallcomid, Acraswx, Kemamide, Armowax, Ethomid, and the like.

The foam height stabilizer, when present, comprises about 0.1% to about 5%, by weight, more preferably about 0.5% to about 3% and most preferably about 1% to about 2%, by weight, of the total abrasive composition.

Particularly where polymer emulsions are used as thickeners or amphoteric surfactants are present, the abrasive composition may additionally include a “neutralizer” to adjust the pH of the composition. Means of adjusting pH are well known to those of skill in the art. Particularly where a polymer emulsion is present it, is desirable to add a base to neutralize the emulsion. This may be accomplished by the addition of one of a number of water soluble bases well known to those of skill in the art. These include, but are not limited to sodium hydroxide, sodium bicarbonate and amine bases such as pyridine and ethylamine and ammonia. In certain preferred embodiments, the neutralizer is triethanolamine and the abrasive composition is adjusted to a neutral pH.

In order to reduce water loss and drying, the abrasive compositions of this invention can contain a hydration agent or humectant. Suitable humectants are well known to those of skill in the art and include, but are not limited to glycerine, and/or polyethylene glycol, and/or polypropylene glycol, and the like.

In certain embodiments, the comprises glycerine and/or polyethylene glycol (PEG). In certain embodiments, the humectant comprises a combination of glycerine and polylethylene glycol (e.g., PEG 400). In certain embodiments, the humectant is present at about 1% to about 15%, more preferably about 2% to about 10%, and most preferably about 3% to about 7%, by weight, of the total abrasive composition.

In certain embodiments, the abrasive compositions of the present invention are made up as aqueous solutions. Thus, in addition to the components recited above, the compositions are largely water (e.g., distilled or deionized water). One of skill will appreciate however, that the compositions can include other components such as dyes, fragrances, various gases to improve foam formation, and the like.

While the abrasive compositions can comprise simply a particulate abrasive and a suspension agent, one preferred embodiment additionally includes a surfactant and/or a humectant, and where necessary to obtain a neutral pH, a neutralizer (e.g., triethanolamine). In certain particularly preferred embodiments, the humectant, when present is a composition of glycerine and polyethylene glycol, while the surfactant, when present, comprises a poly (3) oxyethylene C₁₂₋₁₅ alcohol (e.g., TOMADOL® 25-3), a poly (7) oxyethylene C₁₂₋₁₅ alcohol (e.g., TOMADOL® 25-7), and dioctylsodiumsulfosuccinate (e.g., ACROSOL® OT-75). In certain embodiments, particular embodiments, lacking silica, the particulate abrasive comprises a combination of nepheline syenite and alundum.

As explained herein the abrasive composition of this invention can be optimized for preparation of plastics (e.g., automobile bumpers) for painting operations. Certain “plastic prep” embodiments are illustrated in Table 1.

TABLE 1
Illustrative formulations for abrasive composition suitable for
preparing plastics for painting.

| | Typical Range | Specific |
|---|---|---|
| Component | (% active ingredient) | Formulation |
| Particulate abrasive | 1-80 | 60 |
| Suspension Agent | 0.1-10* | 0.275 |
| Humectant | 1-20* | 7 |
| Surfactant | 0.1-5.0* | 1.67 |
| pH adjuster | 0.1-5* | 1.10 |
| Biocide | 0.001-0.1* | 0.010 |
| Colorant | 0.001-2.0* | 0.020 |
| Scent | 0.001-1.0* | 0.01 |
| Water | remainder | remainder |

*When present.

In certain embodiments, the abrasive compositions of this invention are formulated as silica-free formulations. Certain “silica-free” embodiments are illustrated in Table 2.

TABLE 2
Illustrative formulations for silica-free abrasive compositions.

| | Typical Range | Specific |
|---|---|---|
| Component | (% active ingredient) | Formulation |
| Particulate abrasive | 1-80 | 57.5 |
| Suspension Agent | 0.1-10* | 0.350 |
| Humectant | 1-20* | 7 |
| Surfactant | 0.1-5.0* | 1.67 |
| pH adjuster | 0.1-5* | 0.5 |
| Biocide | 0.001-0.1* | — |
| Colorant | 0.001-2.0* | — |
| Scent | 0.001-1.0* | — |
| Water | Remainder | Remainder. |

*When present.

The abrasive composition can be made by conventional means, typically including the steps of mixing the components of the abrasive material at substantially atmospheric pressure, so as to form a substantially homogeneous mixture. The material can then be packaged in any vessel capable of storing aqueous solutions. Alternatively, where the applicator device includes a reservoir to contain the abrasive composition, the composition may be stored in the applicator device itself.

For example, an applicator device cam include an abrasive pad attached to a handle. The handle may provide a reservoir for storage of the abrasive composition which is then delivered to the face of the abrasive pad through one or more channels. The channels may be sealed with a removable seal (e.g., a perforable foil seal) which may be perforated just prior to use.

The abrasive composition may also be provided in a sprayer or a pressurized spray container. The pressurized spray container may contain a compressed gas that serves both as a propellant and to aid in foam creation.

In certain embodiments, the abrasive compositions are dehydrated and provided as a powder or thick gel. Water can then be added, e.g., immediately prior to use, to restore the composition.

### EXAMPLES

The following examples are offered to illustrate, but not to limit the present invention.

### Example 1

### Preparation Of A Plastic Prep Gel

The following components (as shown in Table 3) were combined at room temperature and at atmospheric pressure by slow stirring to form a abrasive composition for use in the preparation of plastic surfaces for application of paint or other overcoating.

TABLE 3
Formulation of a plastic prep gel.

| | Percentage active | Batch Size |
|---|---|---|
| Ingredient | ingredient/unit | (lbs) |
| Particulate abrasive: | | 6000 |
| Minspar 3 | 60.000% | 3600.000 |
| Humectant: | | |
| Glycerine | 2.000% | 120.000 |
| PEG 400 | 5.000% | 300.000 |
| Surfactant: | | |
| Tomadol 25-7 | 0.500% | 30.000 |
| Tomadol 25-3 | 0.500% | 30.000 |
| Cytec Aerosol OT-75 | 0.670% | 40.200 |
| Suspension agent: | | |
| Noveon Carbopol EZ-1 | 0.275% | 16.500 |
| pH Adjuster: | | |
| Triethanolamine, Base | 1.100% | 66.000 |
| Bioicide | | |
| Rohm and Haas Kathon LX14 | 0.010% | 0.600 |
| Colorant | | |
| Sunchemical 6004 | 0.020% | 1.200 |
| Scent | | |
| Ocean Fresh Scent | 0.025% | 1.500 |
| Water | 29.900% | 1794.000 |

### Example 2

### Preparation Of A Silica-Free Formulation

The following components (as shown in Table 4) were combined at room temperature and at atmospheric pressure by slow stirring to form a “silica-free” abrasive composition for use in the preparation of surfaces for application of paint or other overcoating.

TABLE 4
Formulation of a “Silica-Free” abrasive gel.

| | Percentage | Percentage | |
|---|---|---|---|
| | Active | Active | |
| | Ingredient | Ingredient | |
| | in | per Unit | |
| | Ingredient | Abrasive | Batch Size |
| Ingredient | as supplied | composition. | (lbs) |
| Particulate Abrasive: | | | |
| Alundum (Saint Gobain, 38 | 100% | 2.500% | 150 |
| Alundum Acid Treated-240) | | | |
| Unimin, Nepheline Syenite | 100% | 55.000% | 3300 |
| Humectant: | | | |
| Glycerine | 100% | 2.000% | 120 |
| Polyethylene Glycol 400 | 100% | 5.000% | 300 |
| Surfactant: | | | |
| Tomah, Tomadol, 25-7 | 100% | 0.500% | 30 |
| Tomah, Tomadol, 25-3 | 100% | 0.500% | 30 |
| Cytec, Aerosol OT-75 | 75% | 0.670% | 40.2 |
| Suspension Agent: | | | |
| Noveon, Carbopol EZ-3 | 100% | 0.350% | 21 |
| pH Adjuster: | | | |
| Triethanolomine | 100% | 0.500% | 30 |
| Water: | | | |
| Deionized water | 0 | | 6000 |

### Example 3

### Formulations For Paint Surfaces Comprising Nanoparticles

In another embodiment, this invention provides an abrasive composition particularly well suited for preparing surfaces painted with new nanoceramic clear coated paint now appearing on automobiles. Typically, nanoceramic materials are materials comprising inorganic or organic powders that are manufactured as sizes less than about 500 nm, preferably less than about 100 nm, most preferably less than about 50 nm or 80 nm. In certain embodiments the nanoceramic materials comprise calcium silicates and/or other ceramics and often provide harder, heat tolerant, and more wear resistant surfaces.

The abrasive compositions fo this invention for use in this context are referred to as Clear Cut™”. In certain embodiments, Clear Cut™ is a liquid or gelled abrasive designed to provide uniform and effective abrasion of a nanoceramic based paint so that paint and other overacoating materials can be applied to the surface. In addition, the compositions are designed to be easily removed from the abraded/prepared surface, e.g., with a water wash, and leave the underlying surface clean and ready for application of paint or other overcoating material.

In certain embodiments, the ClearCut™ abrasive compositions utilize a a much harder mineral (aluminum oxide) to cut what we have been told in technical document and industry news letters is a much harder paint surface. This paint includes Nanoceramic particles to reduce incidental scratching of a surface, such as from automatic car washes and the like.

The technology was recently introduced by Mercedes Benz and according to industry news reports will find more and more auto manufactures going to this type of paint in the near future. At this time PPG and BASF are supplying these paints, (PPG patent 6,657,001). Mercedes Benz has noted which vehicles have this paint technology by including a “C” prefix to the normal paint color codes attached to the vehicle.

We have found that white fused aluminum oxide works well in this context and we presently favor the “38 Alundum” 360 grit particle size with a mohs hardness of 9 from Saint Gobain Ceramic Materials, Worchester, Mass. Different size particles would also work deending on the surface finish required (see, e.g., Table 5).

TABLE 5
Illustrative ClearCut ™ formulations.

| Ingredient - | Ingredient - One | | Percentage per |
|---|---|---|---|
| General | embodiment | Range | unit composition |
| Particulate | Saint Gobain, 38 | 50%-80% | 75.000% |
| abrasive | Alundum 360 Grit | | |
| Humectant | Glycerine, Humectant | 1%-15% | 2.000% |
| | PEG 400, Humectant | | 5.000% |
| Surfactant | Tomadol 25-7, Surfactant | <3% | 0.500% |
| | Tomadol 25-3, Surfactant | | 0.500% |
| | Cytec OT-75, Surfactant | | 0.670% |
| Cleaning Agent | D-limonine | 0%-10% | 2.000% |
| Thickener/ | Noveon EZ 3 | 0%-5% | 0.150% |
| suspension | | | |
| agent | | | |
| Ph adjuster | Triethanolamine | 0%-3% | 0.525% |
| | H2O | | 13.655% |
| | Total solids | | 100.000% |

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1: A composition for preparing a plastic surface for application of paint or other overcoating, said composition comprising:
about 1.0% to about 80%, by weight, a particulate abrasive; and
about 0.1% to about 10%, by weight a suspension agent,
wherein said composition lacks an aliphatic hydrocarbon cleaning agent.

2: The composition of claim 1, wherein said particulate abrasive is selected from the group consisting of a pumice, calcium carbonate, ninex, boron nitride, metal carbides, diamond dust, aluminum oxide, and iron oxide.

3: The composition of claim 1, wherein said particulate abrasive comprises a feldspar.

4: The composition of claim 1, wherein said particulate abrasive has a mohs hardness of 9.

5: The composition of claim 1, wherein said particulate abrasive comprises fused aluminum oxide.

6: The composition of claim 1, wherein said particulate abrasive comprises Minspar 3™.

7: The composition of claim 1, wherein said particulate abrasive has a particle size and hardness sufficient to dull a paint finish on said plastic surface.

8: The composition of claim 7, wherein said plastic surface is a surface of a plastic automobile part.

9: The composition of claim 7, wherein said plastic surface is a surface of a plastic automobile bumper.

10: The composition of claim 1, wherein said suspension agent is selected from the group consisting of a cellulose, a starch, an acrylic polymer, a polymer emulsion, and a clay.

11: The composition of claim 10, wherein said suspension agent comprises a copolymers of acrylic acid and a polyalkenyl polyether.

12: The composition of claim 11, wherein said suspension agent is a Carbopol™ copolymer.

13: The composition of claim 11, wherein said suspension agent is selected from the group consisting of CARBOPOL EZ-1™ and CARBOPOL EZ-3™.

14: The composition of claim 1, wherein said composition further comprises a surfactant.

15: The composition of claim 14, wherein said surfactant comprises a high HLB surfactant and a low HLB surfactant.

16: The composition of claim 14, wherein said surfactant further comprises an ionic surfactant.

17: The composition of claim 14, wherein said surfactant comprises a nonionic surfactant.

18: The composition of claim 14, wherein said surfactant comprises a nonionic surfactant.

19: The composition of claim 18, wherein said surfactant comprises an ethoxylated linear alcohol.

20: The composition of claim 18, wherein said surfactant comprises a poly (3) oxyethylene C₁₂₋₁₅ alcohol.

21: The composition of claim 18, wherein said surfactant comprises a poly (7) oxyethylene C₁₂₋₁₅ alcohol.

22: The composition of claim 1, wherein said composition further comprises a humectant.

23: The composition of claim 22, wherein said humectant ranges from about 0.1 to about 20%, by weight, of said composition.

24: The composition of claim 22, wherein said humectant comprises glycerine.

25: The composition of claim 22, wherein said humectant comprises polyethylnene glycol.

26: The composition of claim 1, wherein said composition further comprises a pH adjuster.

27: The composition of claim 1, wherein said composition further comprises:
a surfactant;
a humectant; and
a pH adjuster.

28: The composition of claim 27, wherein
said surfactant comprises Tomadol 25-7, Tomadol 25-3, and Aerosol OT-75;
said humectant comprises glycerine and polyethylene glycol 400;
said suspension agent comprises Carbopol EZ-1;
said pH adjuster comprises triethanolamine; and
water.

29: A method of coating a plastic surface with paint or other overcoating, said method comprising:
abrading said plastic surface with a composition according to claim 1;
removing composition from said surface; and
applying said paint or other overcoating to said plastic surface.

30: The method of claim 29, wherein said plastic surface is not pre-baked prior to application of said paint or other overcoating.

31: The method of claim 29, wherein said plastic surface is not degreased prior to application of said paint or other overcoating.

32: The method of claim 29, wherein said plastic surface is a surface of a component for a motor vehicle.

33: The method of claim 29, wherein said plastic surface is a surface of a bumper for a motor vehicle.

34: A method of preparing a plastic surface for coating with paint or other overcoating material, said method comprising:
providing an article of manufacture comprising a plastic surface; and
abrading said plastic surface with a composition according to claim 1.

35: The method of claim 33, wherein said plastic surface is not pre-baked prior to coating with paint or other overcoating.

36: The method of claim 33, wherein said plastic surface is not degreased prior to coating with paint or other overcoating.

37: The method of claim 33, wherein said plastic surface is a surface of a component for a motor vehicle.

38: The method of claim 33, wherein said plastic surface is a surface of a bumper for a motor vehicle.

39: A composition for preparing a surface for application of paint or other overcoating, said composition comprising:
about 1.0% to about 80%, by weight, a particulate abrasive, wherein said particulate abrasive lacks silica; and
about 0.1% to about 10%, by weight a suspension agent.

40: The composition of claim 39, wherein said particulate abrasive is selected from the group consisting of a pumice, calcium carbonate, ninex, boron nitride, metal carbides, diamond dust, aluminum oxide, and iron oxide.

41: The composition of claim 39, wherein said particulate abrasive comprises alundum.

42: The composition of claim 39, wherein said particulate abrasive comprises nepheline syenite.

43: The composition of claim 39, wherein said particulate abrasive has a mohs hardness of 9.

44: The composition of claim 39, wherein said particulate abrasive comprises fused aluminum oxide.

45: The composition of claim 39, wherein said composition lacks an aliphatic hydrocarbon cleaning agent.

46: The composition of claim 39, wherein said particulate abrasive has a particle size and hardness sufficient to dull a paint finish on said surface.

47: The composition of claim 39, wherein said surface is a surface of a motor vehicle.

48: The composition of claim 39, wherein said surface is a painted surface of a motor vehicle.

49: The composition of claim 39, wherein said suspension agent is selected from the group consisting of a cellulose, a starch, an acrylic polymer, a polymer emulsion, and a clay.

50: The composition of claim 49, wherein said suspension agent comprises a copolymer of acrylic acid and a polyalkenyl polyether.

51: The composition of claim 50, wherein said suspension agent is a Carbopol™ copolymer.

52: The composition of claim 50, wherein said suspension agent is selected from the group consisting of CARBOPOL EZ-1™, and CARBOPOL EZ-3 ™.

53: The composition of claim 39, wherein said composition further comprises a surfactant.

54: The method of claim 53, wherein said surfactant comprises a high HLB surfactant and a low HLB surfactant.

55: The method of claim 53, wherein said surfactant further comprises an ionic surfactant.

56: The composition of claim 53, wherein said surfactant comprises a nonionic surfactant.

57: The composition of claim 53, wherein said surfactant comprises a nonionic surfactant.

58: The composition of claim 57, wherein said surfactant comprises an ethoxylated linear alcohol.

59: The composition of claim 57, wherein said surfactant comprises a poly (3) oxyethylene C₁₂₋₁₅ alcohol.

60: The composition of claim 57, wherein said surfactant comprises a poly (7) oxyethylene C₁₂₋₁₅ alcohol.

61: The composition of claim 39, wherein said composition further comprises a humectant.

62: The composition of claim 61, wherein said humectant ranges from about 0.1 to about 20%, by weight, of said composition.

63: The composition of claim 61, wherein said humectant comprises glycerine.

64: The composition of claim 61, wherein said humectant comprises polyethylnene glycol.

65: The composition of claim 39, wherein said composition further comprises a pH adjuster.

66: The composition of claim 39, wherein said composition further comprises:
a surfactant;
a humectant; and
a pH adjuster.

67: The composition of claim 27, wherein
said surfactant comprises Tomadol 25-7, Tomadol 25-3, and Aerosol OT-75;
said humectant comprises glycerine and polyethylene glycol 400;
said suspension agent comprises Carbopol EZ-3;
said pH adjuster comprises triethanolamine; and
water.

68: A method of preparing a surface for application of a finish, said method comprising:
abrading said surface with an abrasive composition of claim 39; and
removing said abrasive composition from said surface.

69: The method of claim 68, wherein said surface is a metal surface.

70: The method of claim 68, wherein said surface is the surface of a motor vehicle.

71: The method of claim 68, wherein said surface is the painted surface of an automobile.

72: A method of coating a surface with paint or other overcoating, said method comprising:
abrading said plastic surface with an abrasive composition of claim 39; and
removing composition from said surface; and
applying said paint or other overcoating to said surface.

73: The method of claim 72, wherein said surface is a surface of an automobile or automobile part.

74: The method of claim 72, wherein said surface is a painted surface of an automobile.

75: The method of claim 72, wherein said removing comprises washing said surface with water.

76: A method of coating a painted surface, wherein said painted surfaces comprises nanoceramic particles, said method comprising:
i) abrading said paint surface with a foam or gel comprising:
about 1.0% to about 80% by weight of a particulate abrasive wherein said particulate abrasive is an aluminum oxide having a mohs hardness of about 9;
about 0.1% to about 10% by weight of a suspension agent;
a surfactant; and
ii) removing said foam or gel from said surface.

77: The method of claim 76, wherein said particulate abrasive comprises about a 360 grit particle size.

78: The method of claim 76, wherein said foam or gel further comprises a cleaning agent comprising an aliphatic hydrocarbon

79: The method of claim 76, wherein said suspension agent is selected from the group consisting of a cellulose, a starch, an acrylic polymer, a polymer emulsion, or a clay.

80: The method of claim 76, wherein said particulate abrasive comprises about 10% to about 50% by weight of said composition.

81: The method of claim 76, wherein said surfactant comprises a high HLB surfactant and a low HLB surfactant.

82: The method of claim 76, wherein said surfactant further comprises an ionic surfactant..

83: The method of claim 76, wherein said cleaning agent comprises about 0.1% to about 5% by weight of said composition.

84: The method of claim 76, wherein said cleaning agent comprises a water soluble alcohol.

85: The method of claim 76, wherein said composition further comprises a neutralizing agent.

86: The method of claim 78, wherein said cleaning agent comprises one or more agents selected from the group consisting of ethyl alcohol, propyl alcohol, isopropyl alcohol, methyl alcohol, ethylene diol, propylene diol, ethanolamine, D-limonine, dodecane, and isopar G, ethoxylate, and Carvone.

87: The method of claim 78, wherein said cleaning agent is ethyl alcohol and D-Limonine.

88: The method of claim 76, wherein said composition further comprises a foam height stabilizer.

89: The method of claim 88, wherein said foam height stabilizer is ninol.

90: The method of claim 76, wherein said surfactant comprises a nonionic high HLB surfactant, a nonionic low HLB surfactant, and an ionic surfactant.

91: The method of claim 76, wherein said particulate abrasive comprises about 50 to about 85% of said composition by weight.

92: The method of claim 79, wherein:
said particulate abrasive comprises about 75% of said composition by weight.
said nonionic high HLB surfactant and nonionic low HLB surfactant each comprise about 0.5%, by weight, of said composition;
said ionic surfactant comprises about 0.67%, by weight, of said composition;
said cleaning agent is D-Limonine and comprises about 2%, by weight, of said composition.

93: The method of claim 92, wherein said composition further comprises a humectant.
